(19) United States
(12) Patent Application Publication
(10) Pub. No.: US 2008/0084461 A1
(43) Pub. Date: Apr. 10, 2008

(54) INK TANK AND INK JET PRINTER USING THE SAME

(75) Inventors: In-su LEE, Suwon-si (KR); Jin-ho Park, Yongin-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/767,772

(22) Filed: Jun. 25, 2007

(30) Foreign Application Priority Data
Oct. 4, 2006 (KR) 2006-0097639

(51) Int. Cl. B41J 2/175

(52) U.S. Cl. 347/86

(57) ABSTRACT

An ink tank to store ink which is supplied to a printing head installed to an ink jet printer, and to be detachably mounted to the ink jet printer, includes a main body to store the ink and having an ink outlet part, a tubular body which is accommodated in the main body and includes a first end part which communicates with the ink outlet part and a second end part which includes an ink inlet facing a bottom surface of the main body, and a filter which is connected to the tubular body.

### CROSS-REFERENCE TO RELATED APPLICATIONS

This application claims priority under 35 U.S.C. §119(a) from Korean Patent Application No. 2006-0097639, filed, Oct. 4, 2006, in the Korean Intellectual Property Office, the disclosure of which is incorporated herein in its entirety by reference.

### BACKGROUND OF THE INVENTION

1. Field of the Invention

The present general inventive concept relates to an ink tank and an ink jet printer using the same to simplify a filter replacement and to reduce a pressure loss.

2. Description of the Related Art

A conventional ink jet printer jets ink to form an image, and includes a printing head formed with a nozzle to jet the ink, and an ink tank supplying the ink to the printing head. There are two types of ink cartages, namely an integrated type ink cartridge which has an integrated printing head and ink tank body to be integrally mounted and detached, and a separate type ink cartridge which has the ink tank only detachable from and mountable to the printer with the printing head mounted to a printer.

In the separate type ink cartridge, if the ink tank is mounted to the printing head, an ink flow path routing from the ink tank to the nozzle of the printing head may be formed.

However, in the conventional separate type ink cartridge, it is impossible to replace only the filter and increase the size of the filter due to a configuration of the printing head since the filter for filtering a foreign substance and a bubble contained in ink in the ink flow path is installed inside the printing head.

Also, if ink containing air (i.e., the air enters the ink through the nozzle or when the ink tank is detached and/or mounted) penetrates the filter inside the printing head, an excessive pressure loss happens before and after penetration of the ink.

Also, since the printing head is permanently mounted to the ink jet printer, it is impossible to replace the filter when a lifetime of the filter expires.

### SUMMARY OF THE INVENTION

The present general inventive concept provides an ink tank in an ink jet printer, the ink tank to freely allow varying a size of a filter, and to easily replace a filter to reduce a pressure loss.

Additional aspects and utilities of the present general inventive concept will be set forth in part in the description which follows and, in part, will be obvious from the description, or may be learned by practice of the present general inventive concept.

The foregoing and/or other aspects and utilities of the present general inventive concept may also be achieved by providing an ink tank detachably mounted to the ink jet printer, comprising a main body to store ink therein, and comprising an ink outlet part formed on a side thereof, a tubular body disposed in the main body and detachably connected to one end of the ink outlet part, and a filter connected to the other end of the tubular body.

The other end of the tubular body may be lower than the one end of the ink outlet part.

The main body may comprise a second side as a boom, and the other end of the tubular body is disposed closer to the second side than the one end.

The main body may comprise a second side as a bottom lower than the ink outlet part, and the other end is spaced apart from the second side by a distance to prevent a bubble from being introduced through the filter.

The tubular body may comprise a coupling part to be connected to the ink outlet part in an ink supplying direction, a bent part extended from the coupling part and bent in a second direction, and an end formed on a portion of the bent part to form an ink inlet part to supply the ink from an inside area of the main body to the ink outlet part.

The ink inlet part may comprise an opening and shifting member to open or shut a path of the ink from an inside area of the main body through the ink inlet part, and the tubular body is disposed between the ink inlet part and the inside of the main body.

A level of the ink may be lowered according to consumption of the ink in the main body, and the filter and the other end of the tubular body is located at a lowest position of the tubular body to prevent a bubble from being introduced through the filter when the ink level is lowered.

The tubular body may comprise a first end part to communicate with the ink outlet part, and a second end part comprising an ink inlet to face a bottom surface of the main body.

The filter may be disposed inside the tubular body in parallel with the bottom surface of the main body.

The ink inlet of the tubular body may be adjacent to the bottom surface of the main body, and the filter may be provided in the ink inlet of the tubular body.

The tubular body may have a bent shape.

The foregoing and/or other aspects and utilities of the present general inventive concept may also be achieved by providing an ink jet printer comprising an ink tank, comprising a main body to store ink therein, and comprising an ink outlet part formed on a side thereof a tubular body disposed in the main body and detachably connected to one end of the ink outlet part, and a filter connected to the other end of the tubular body.

The ink jet printer may further comprise a printing head having a pipe coupled to the tubular body to receive the ink.

### BRIEF DESCRIPTION OF THE DRAWINGS

The above and/or other aspects and utilities of the present general inventive concept will become apparent and more readily appreciated from the following description of the exemplary embodiments, taken in conjunction with the accompanying drawings, in which:

FIG. 1 is a combined cross sectional view of an ink tank and a printing head according to an exemplary embodiment of the present general inventive concept;

FIG. 2 is a graph illustrating a pressure drop in a filter of the ink tank in FIG. 1; and

FIG. 3 is a graph illustrating a pressure drop in a filter, a size of which is smaller than a size of the filter of the ink tank in FIG. 2.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The exemplary embodiments are described below so as to explain the present general inventive concept by referring to the figures.

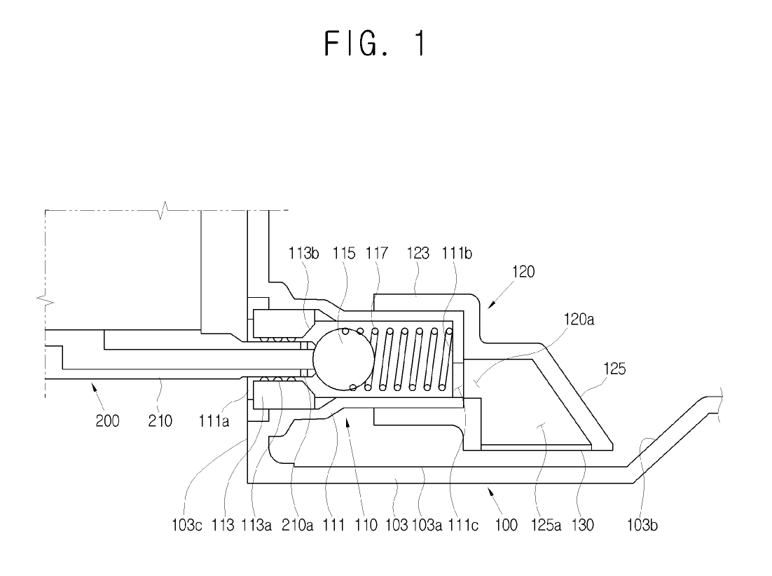

As illustrated in FIG. 1, an ink tank 100 usable with an image forming apparatus, such as a printer, according to an exemplary embodiment of the present general inventive concept comprises a main body 103, an ink outlet part 110, a tubular body 120 and a filter 130. The image forming apparatus may include a structure to convey a recording medium and guide elements to form or print an image on the conveyed recording medium using ink.

The main body 103 stores ink which is supplied to a printing head 200. The main body 103 may be formed with an inclined surface 103b which is inclined toward a bottom surface 103a so that a remaining ink can be gathered in the bottom surface 103a as the ink is consumed. An air communicating hole (not illustrated) is formed at an upper side of the main body 103. The air communicating hole maintains an atmospheric pressure to be applied to an upper surface of the ink stored in the ink tank 100. Accordingly, if ink is ejected through a nozzle (not illustrated) of the printing head 200 to result in consumption of the ink in the printing head 200, the ink of the ink tank 100 moves to the printing head 200 according to the consumed amount by means of a capillary phenomenon so that the printing head 200 can be refilled.

The ink outlet part 110 may be positioned at a side surface 103c of the main body 103, adjacent to the bottom surface 103a of the main body 103 so that the ink can be used up to the bottom surface 103a of the main body 103. Alternatively, the ink outlet part 110 may be positioned at other positions of the main body 103.

As illustrated in FIG. 1, the ink outlet part 110 comprises an ink outlet pipe 111, a packing member 113, an opening shutting member 115 and an elastic member 117.

One end part of the ink outlet pipe 111 is formed with an insertion opening 111a to which an ink inlet pipe 210 of the printing head 200 is inserted, and the other end part of the ink outlet pipe 111 is formed with a seat part 111b in which the elastic member 117 is seated. Also, in a predetermined area of the other end part of the ink outlet pipe 111 to which the elastic member 117 is not seated, a tubular body exchange opening 111c is formed to be connected to the tubular body 120.

To improve productivity, the ink outlet pipe 111 may be integrally formed with the main body 103. Also, the ink outlet pipe 111 may protrude toward an inner side of the main body 103 to prevent interference with the printing head 200.

The packing member 113 is accommodated to the insertion opening 111a side of the ink outlet pipe 111 to prevent the ink from leaking when the ink inlet pipe 210 of the printing head 200 is inserted into the insertion opening 111 a. A protrusion 113a is formed at an inner surface of the packing member 113, the inner surface being contacted and pressed with an outer surface of the ink inlet pipe 210 to maintain a sealed state against the ink inlet pipe 210. Also, a taper surface 113b is formed toward the opening shutting member 115.

As illustrated in FIG. 1, the opening shutting member 115 has a spherical shape, and is elastically supported toward the packing member 113 by the elastic member 117. Before the ink tank 100 is mounted to the printing head 200, the opening shutting member 115 forcedly contacts the taper surface 113b of the packing member 113 by the elastic member 117 to prevent the ink from leaking from the main body 103 of the ink tank 100.

When the ink inlet pipe 210 of the printing head 200 is inserted, that is, when the ink tank is mounted to the printing head 200, the ink inlet pipe 210 pushes the opening shutting member 115 to be distanced from the taper surface 113b of the packing member 113 so that a distal end of the ink inlet pipe 210 contacts the opening shutting member 115, and the ink can flow to the printing head 200 through an opening 210a of the ink inlet pipe 210. The opening 210a may be formed on a side of the distal end of the ink inlet pipe 210 to allow the ink to flow therethrough. Accordingly, the ink stored in the main body 103 can be supplied to a nozzle (not illustrated) of the printing head 200.

As illustrated in FIG. 1, the elastic member 117 comprises a compression coil spring. Alternatively, the elastic member 117 may comprise a plate spring or other elastic members known to one of ordinary in the art.

As illustrated in FIG. 1, the tubular body 120 comprises a coupling part 123 coupled with the ink outlet part 110, and a bent part 125 extending from the coupling part 123 to be bent toward the side of the bottom surface 103a of the main body 103. As illustrated in FIG. 1, the coupling part 123 and the bent part 125 may be formed as an integrated body.

The coupling part 123 may be formed of a ductile plastic material. An inner diameter of the coupling part 123 is smaller than an outer diameter of the ink outlet pipe 111 of the ink outlet part 110 to be forcedly fitted to the ink outlet pipe 111. Alternatively, an engagement protrusion (not illustrated) may be provided to one of the coupling part 123 and the ink outlet pipe 111, and an engagement groove (not illustrated) may be provided to the other thereof to be coupled to the engagement protrusion. Alternatively, other known coupling means may be applied thereto as long as the coupling strength is maintained to be able to prevent the tubular body 120 from being separated from the ink outlet part 110 while the coupling part 123 is easily detachably coupled to the ink outlet pipe 111.

As illustrated in FIG. 1, one side of the bent part 125 is connected with the coupling part 123, and the other side thereof is formed with an ink inlet 125a which is opened toward the bottom surface 103a of the main body 103. The ink inlet 125a of the bent part 125 may be formed adjacently to the bottom surface 103a to improve a use efficiency of the ink stored in the main body 103. The ink inlet 125a of the bent part 125 is located lower than the coupling part 123 and is spaced apart from the bottom surface 103a by a distance shorter than a distance between the bottom and the ink outlet part exchange opening 120a.

Between the coupling part 123 and the bent part 125, an ink outlet part exchange opening 120a is formed to be connected with the tubular body exchange opening 111c. Accordingly, the ink supplied from the ink inlet 125a can flow to the printing head 200 through the ink outlet part exchange opening 120a and the tubular body exchange opening 111c.

As illustrated in FIG. 1, the ink inlet 125a may be bigger than the ink outlet part exchange opening 120a, and the cross sectional area of the ink inlet 125a may taper toward the ink outlet part exchange opening 120a. Accordingly, the flow velocity of the ink which is supplied from the ink inlet 125a becomes faster as the ink flows toward the ink outlet part exchange opening 120a so that the stored ink can be smoothly supplied to the printing head 200.

Also, if the ink inlet 125a is enlarged, the size of the filter 130 located in an ink path of the tubular body 120 can be increased. Also, by preparing the tubular body 120 according to a size of the ink inlet 125a while maintaining an original size of the coupling part 123 to fit the ink outlet pipe 111, and by adopting the tubular body 120 having the ink inlet 125a corresponding to a necessary filter size, filters with various sizes can be used without transforming other components.

As illustrated in FIG. 1, the filter 130 is installed at the ink inlet 125a of the bent part 125. As necessary, the filter 130 may be placed between the ink inlet 125a and the ink outlet part exchange opening 120a. Accordingly, the filter 130 can be replaced by exchanging the tubular body 120 only.

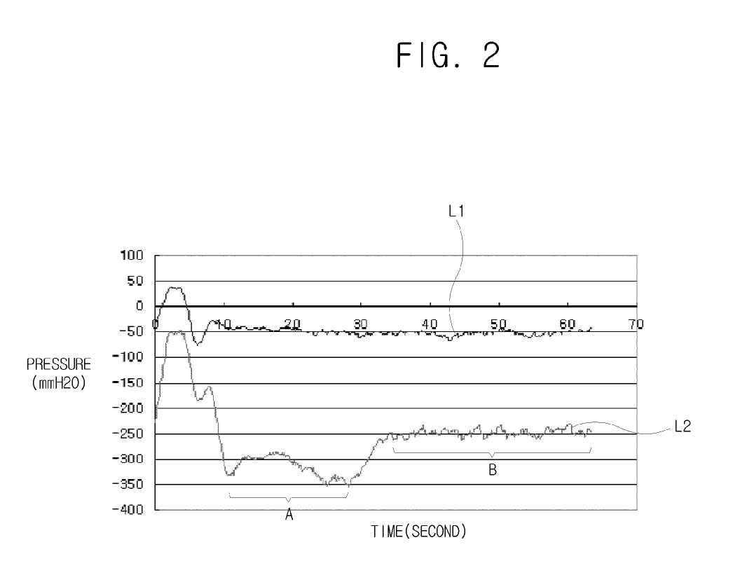

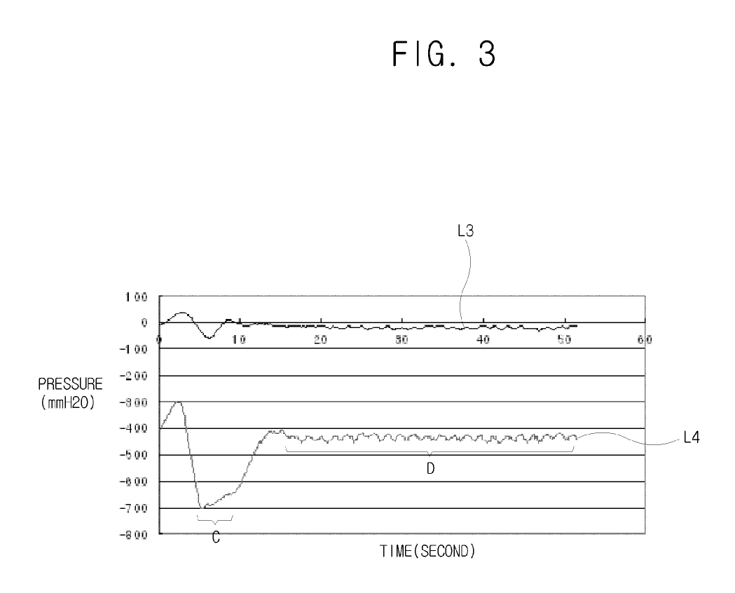

The filter 130 may be installed in parallel with the bottom surface 103a of the main body 103. By installing the filter 130 in parallel with the bottom surface 103a, the whole filter 130 can be immersed in ink to prevent bubbles from being introduced. Since specific gravity of bubbles existing in the ink tank 100 is smaller than specific gravity of the ink, the bubbles rise over the top surface of the ink. Accordingly, since bubbles do not typically exist on the bottom surface 103a of the main body 103, the ink not containing the bubbles penetrates the filter 130 to reduce a pressure drop behind the filter 130. A level of the ink is lowered according to consumption of the ink, and until a level of the ink is not lowered by the distance, the bubbles will not be introduced into the filter. This is understood by the experiment results as illustrated in FIGS. 2 and 3. In a conventional printer, a filter is located inside a printing head where ink containing bubbles penetrates the filter, thereby resulting in a large drop in pressure. The larger the pressure drop, the harder a normal image realization is due to an improper supply of ink.

The filter 130 comprises a plate having minute holes (not illustrated) which are formed along a surface thereof. The plate may comprise a silicon wafer, a plastic plate and a metal plate which is capable of being processed to include the minute holes. Sizes of the minute holes may be smaller than the diameter of the nozzle to be able to successfully screen a foreign substance or bubbles. Alternatively, as necessary, the size of the minute holes may be identical to or bigger than the diameter of the nozzle according to a use condition.

FIGS. 2 and 3 illustrate graphs comparing pressure drops before and after penetration, namely where a pure ink penetrates the filter 130 or where an ink containing bubbles penetrates the filter 130 under identical conditions except a varying size of the filter 130. As illustrated in FIGS. 2 and 3, data L1 and L3, respectively, refer to pressure values before penetration of the filter 130, and data L2 and L4, respectively, refer to pressure values after penetration of the filter 130.

As illustrated in FIG. 2, a pressure value A after ink containing bubbles penetrates the filter 130 is approximately −330 mmH₂O, and when compared to −50 mmH₂O, which is a pressure value before penetration, a pressure drops by −280 mmH₂O. A pressure value B after a pure ink not containing bubbles penetrates the filter 130 is −250 mmH₂O on average, and when compared to −50 mmH₂O, which is a pressure value before penetration, a pressure drops by −200 mmH₂O. Accordingly, since a larger pressure exists when the pure ink penetrates the filter 130, than when the ink containing the bubbles penetrates the filter 130 by 80 mmH₂O, the ink can be more smoothly supplied to the printing head 200 originally.

FIG. 3 discloses an experiment result in which the size of the filter 130 of the ink tank 100 (a cross sectional area of the ink inlet 125a) is smaller than the size of the filter 130 of the ink tank 100 (a cross sectional area of the ink inlet 125a) in FIG. 2.

As illustrated in FIG. 3, a pressure value D which can be detected after a pure ink which penetrates the filter 130, is larger than a pressure value C which can be detected after ink containing bubbles penetrates the filter 130. When the pure ink penetrates the filter 130, a drop in pressure can be approximately −400 mmH₂O. When the ink containing the bubbles penetrates the filter 130, a drop in pressure can be approximately −600 mmH₂O. Accordingly, the pressure after the pure ink penetrates the filter 130 is larger than the pressure after the ink containing the bubbles penetrates the filter 130 by 200 mmH₂O.

Also, as illustrated in FIGS. 2 and 3, two distinct drops in pressure when the pure ink penetrates the filter 130 are compared. As illustrated in FIG. 2, the pressure drop is −280H₂O. As illustrated in FIG. 3, in which the size of the filter 130 is bigger than that in the case of FIG. 2, the pressure drop is −400H₂O. Accordingly, as the size of the filter 130 is increased, a drop in pressure reduces. Accordingly, by increasing the size of the filter 130, ink can be smoothly supplied to the printing head 200 under the same conditions.

If it is necessary to enlarge the size of the filter 130 to improve an ink supplying ability according to an operation environment of the ink jet printer, the filter can be replaced to have a bigger size by changing the size of the ink inlet 125a of the tubular body 120.

As described above, an ink tank according to the present general inventive concept provides the following effects.

By placing a filter inside an ink tank, which can include placing a filter adjacently to a bottom surface, the filter can always be immersed in ink to minimize a pressure drop which is generated if the ink penetrates the filter. Accordingly, the ink can be more smoothly supplied to a printing head.

Also, by changing a shape of a tubular body, which can include changing the size of an ink inlet, filters with various sizes can be mounted.

Also, if an ink inlet is adjacent to a bottom surface of an ink tank, even the ink gathered in the bottom surface can be used to form an image.

Also, since a tubular body is detachable and mountable and a filter is placed inside an ink tank, the filter can be replaced by replacing the tubular body or the ink tank.

Although a few exemplary embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An ink tank detachably mounted to the ink jet printer, comprising:
a main body to store ink therein, and comprising an ink outlet part formed on a side thereof;
a tubular body disposed in the main body and detachably connected to one end of the ink outlet part; and
a filter connected to the other end of the tubular body.

2. The ink tank of claim 1, wherein the other end of the tubular body is lower than the one end of the ink outlet part.

3. The ink tank of claim 1, wherein the main body comprises:
a second side as a boom, and the other end of the tubular body is disposed closer to the second side than the one end.

4. The ink tank of claim 1, wherein the main body comprises:
a second side as a bottom lower than the ink outlet part, and the other end is spaced apart from the second side by a distance to prevent a bubble from being introduced through the filter.

5. The ink tank of claim 1, wherein the tubular body comprises:
a coupling part to be connected to the ink outlet part in an ink supplying direction;
a bent part extended from the coupling part and bent in a second direction; and
an end formed on a portion of the bent part to form an ink inlet part to supply the ink from an inside area of the main body to the ink outlet part.

6. The ink tank of claim 1, wherein the ink inlet part comprises an opening and shifting member to open or shut a path of the ink from an inside area of the main body through the ink inlet part, and the tubular body is disposed between the ink inlet part and the inside of the main body.

7. The ink tank of claim 1, wherein a level of the ink is lowered according to consumption of the ink in the main body, and the filter and the other end of the tubular body is located at a lowest position of the tubular body to prevent a bubble from being introduced through the filter when the ink level is lowered.

8. The ink tank according to claim 1, wherein the tubular body comprises a first end part to communicate with the ink outlet part, and a second end part comprising an ink inlet to face a bottom surface of the main body.

9. The ink tank according to claim 8, wherein the filter is disposed inside the tubular body in parallel with the bottom surface of the main body.

10. The ink tank according to claim 8, wherein the ink inlet of the tubular body is adjacent to the bottom surface of the main body, and the filter is provided in the ink inlet of the tubular body.

11. The ink tank according to claim 8, wherein the tubular body has a bent shape.

12. An ink jet printer, comprising:
an ink tank, comprising:
a main body to store ink therein, and comprising an ink outlet part formed on a side thereof,
a tubular body disposed in the main body and detachably connected to one end of the ink outlet part, and
a filter connected to the other end of the tubular body.

13. The ink jet printer of claim 12, further comprising:
a printing head having a pipe coupled to the tubular body to receive the ink.
